(19) United States
(12) Patent Application Publication
(10) Pub. No.: US 2013/0137608 A1
(43) Pub. Date: May 30, 2013

(54) Methods of Removing Deposits of Oil and Gas Applications

(71) Applicants: Zen-Yu Chang, Conroe, TX (US); Charles D. Roberts, Willoughby Hills, OH (US)

(72) Inventors: Zen-Yu Chang, Conroe, TX (US); Charles D. Roberts, Willoughby Hills, OH (US)

(73) Assignee: THE LUBRIZOL CORPORATION, Wickliffe, OH (US)

(21) Appl. No.: 13/701,572

(22) PCT Filed: Jun. 15, 2011
(86) PCT No.: PCT/US2011/040410

§ 371 Date: Feb. 14, 2013

Related U.S. Application Data
(60) Provisional application No. 61/354,802, filed on Jun. 15, 2010.

(51) Int. Cl. C09K 8/52

(52) U.S. Cl. CPC C09K 8/52
USPC 507/90; 510/188

(57) ABSTRACT

This invention relates to compositions and methods for controlling and/or removing deposits in oil and/or gas handling equipment, and more specifically relates to controlling and/or removing deposits from the walls of oil and/or gas pipelines.

### BACKGROUND OF THE INVENTION

This invention relates to compositions and methods for controlling and/or removing deposits in oil and/or gas handling equipment, and more specifically relates to controlling and/or removing deposits from the walls of oil and/or gas pipelines.

To meet the significant growth in oil and gas demand today, exploration is moving to uncharted, ultra-deep water locations and production is being considered in locations previously considered to be off-limits. Further, much of the existing infrastructure typically operates well beyond its designed capabilities. This overreach creates significant technical challenges in all areas of production; however, no challenge is more difficult than preserving infrastructure integrity.

Deposit control additives and/or corrosion inhibitors are frequently introduced into oil and gas fluids to aid in maintaining infrastructure integrity. These additives are added to a wide array of systems and system components, such as cooling systems, refinery units, pipelines, steam generators, and oil or gas producing and production water handling equipment.

Depending on the particular system, solids can build up to form a layer up to several centimeters thick. Deposits of such hydrocarbonaceous materials and finely divided inorganic solids form on the inner surfaces of the lines. These deposits may include, for example, sand, clays, sulfur, napthenic acid salts, corrosion byproducts, and biomass bound together with oil. The particles become coated with hydrocarbonaceous materials and subsequently become coated with additional quantities of heavy hydrocarbonaceous material in the flowlines, settling tank, and the like. Collectively, this layer of deposits is often referred to as “schmoo” in the petroleum industry.

Schmoo is a solid or paste-like substance that adheres to almost any surface with which it comes in contact and is particularly difficult to remove. Whenever possible, pipelines known to have such deposited materials or that form pools of water at low spots are routinely pigged to remove the material. In many cases, however, it may not be feasible to pig lines due to the construction configuration, variable pipeline diameter, or the lack of pig launchers and receivers. The material often accumulates on, for example, the bottom or around the circumference of the pipe. Additionally, even after maintenance pigging, schmoo still often resides inside pits in metal surfaces. As discussed above, these situations create a significant risk for increased corrosion. Schmoo can also accumulate to a thickness such that it flakes off the inner surfaces of the pipe and deposits in the lower portion of a well, the lower portion of a line or the like, and plugs the line or the formation in fluid communication with the pipe.

In view of these difficulties there exists an ongoing need for improved methods of removing deposits from pipelines to optimize pipeline transmission capabilities. An ideal solution would include a chemical-based process to remove the deposits, prevent further deposits from forming in the system, and optimize water volume (in many cases including maximizing water injectivity).

### SUMMARY OF THE INVENTION

The present invention provides a method of removing deposits in oil and/or gas handling equipment. The methods of the invention include the steps of: (I) supplying to internal surfaces of said equipment a composition that contains: (a) an additive component and (b) a hydrocarbon solvent that is liquid at 20 degrees C. The additive component contains one or more of the following additives:

(i) a quaternary ammonium salt comprising the reaction product of: (1) the reaction of a hydrocarbon substituted acylating agent and a compound having an oxygen or nitrogen atom capable of condensing with said acylating agent and further having a tertiary amino group; and (2) a quaternizing agent suitable for converting the tertiary amino group to a quaternary nitrogen;

(ii) a hydrocarbon substituted with at least two carboxy functionalities in the form of acids or one or more anhydrides; or

(iii) a hydrocarbon substituted benzene sulfonic acid; and where the additive composition.

The additive composition may further include (c), an additive component, which may contain one or more dispersants and where the additives present in component (c) are different from the additives in component (a). For example, component (c) may contain a dispersant derived from the reaction of a polyisobutylene succinic anhydride and a polyamine; a dispersant derived from the reaction of a polyisobutylene succinic anhydride and a polyol; a dispersant derived from the reaction of a polyisobutylene succinic anhydride, a polyol and a polyamine, or combinations thereof.

In some embodiments the methods of the present invention are used with flowlines, pipelines, injection lines, wellbore surfaces, storage tanks, process equipment, vessels and/or water injection systems. In some embodiments the methods of the invention are used to remove deposits from the internal wall of equipment, for example a pipeline, where said composition is supplied to the wall and/or internal surface of said equipment.

The invention further provides an oil and/or gas handling equipment deposit control composition where the composition includes: (a) an additive component, (b) a hydrocarbon solvent that is liquid at 20 degrees C., and (c) an optional additive component, containing one or more dispersants, where the additives of component (c), when present, are different from the additives of component (a).

The invention further provides methods of using the described compositions to control deposits in oil and/or gas handling equipment. The invention includes the use of the compositions described herein to control deposits in oil and/or gas handling equipment, and more specifically in with flowlines, pipelines, injection lines, wellbore surfaces, storage tanks, process equipment, and/or vessels.

### DETAILED DESCRIPTION OF THE INVENTION

Various preferred features and embodiments will be described below by way of non-limiting illustration.

“Hydrocarbonaceous deposit”, also referred to as “deposit”, refers to any deposit including at least one hydrocarbon constituent and forming on the inner surface of flowlines, pipelines, injection lines, wellbore surfaces, storage tanks, process equipment, vessels, the like, and other components in oil and gas applications. Such deposits also include “schmoo,” which refers to a solid, paste-like, or sludge-like substance that adheres to almost any surface with which it comes in contact and is particularly difficult to remove. Deposits contributing to schmoo may include, for example, sand, clays, sulfur, naphthenic acid salts, corrosion byproducts, biomass, and other hydrocarbonaceous materials bound together with oil. These terms are used interchangeably herein. In some embodiments the deposits controlled and/or removed by the present invention are organic and/or hydrocarbonaceous deposits as described above. In some of the embodiments the methods are not used to control and/or remove gas hydrate deposits.

### FIELD OF THE INVENTION

This invention accordingly provides novel compositions and methods for removing hydrocarbonaceous deposits in oil and gas applications. The disclosed compositions exhibit superior performance. The compounds and compositions of the invention can be used in any system exposed to fluids (i.e., liquid, gas, slurry, or mixture thereof). Moreover, the compositions of the invention may be used in any component or any part of the oil and gas system where hydrocarbonaceous deposits are a concern, including, for example, flowlines, pipelines, injection lines, wellbore surfaces, and the like.

The present invention may also improve corrosion prevention in the described equipment. In some embodiments the methods of the present invention lead to reduced corrosion. In some embodiments the methods of the present invention enable corrosion inhibitors present in the system to work more effectively. In other embodiments the methods of the present invention are used solely for removing deposits.

### The Methods

The present invention provides methods of controlling and/or removing hydrocarbonaceous deposits in oil and/or gas handling equipment. The methods include the steps of supplying the compositions described herein to the interior surfaces and/or walls of the oil and/or gas handling equipment, and specifically to the surfaces of such equipment where deposits may form.

The effective amount of active ingredient in a composition required to sufficiently remove schmoo varies with the system in which it is used. Methods for monitoring the severity of deposits in different systems are well known to those skilled in the art and may be used to decide the effective amount of active ingredient required in a particular situation. The described compounds may be used to impart the property of hydrocarbonaceous deposit removal to a composition for use in an oil or gas field application and may have one or more other functions, such as corrosion inhibition.

In practice, the compositions of the invention may be added to the flow line to provide an effective treating dose of the described compound(s) from about 0.01 to about 5,000 ppm. In some embodiments such doses may be intermittent (i.e., batch treatment) to remove hydrocarbonaceous deposits. In a further embodiment, such doses may be continuous/maintained and/or intermittent.

In one embodiment, the described composition is dosed to provide from about 0.1 to about 500 ppm of the compound(s). In a more preferred embodiment, the dose is from about 1 to about 250 ppm.

In other embodiments the dosage rates for batch treatments typically range from about 10 to about 400,000 ppm. In one embodiment, the flow rate of the flow line in which the composition is used is between 0 and 100 feet per second. In another embodiment the flow rate is between 0.1 and 50 feet per second. In some cases, the compounds of the invention may be formulated with a diluent such as a mineral oil or even in some embodiments with water in order to facilitate addition to the flow line. In other embodiments the additive is provided in a composition that is substantially free of water, or even free of water.

In some embodiments oil and/or gas handling equipment of the invention include flowlines, pipelines, injection lines, wellbore surfaces, storage tanks, process equipment, vessels, water injection systems, and combinations thereof. In some embodiments oil and/or gas handling equipment of the invention include pipelines.

In any one of the embodiments described above, the methods of the present invention may also include the use of a pipeline pig.

The Compositions The compositions of the invention include (a) an additive component, (b) a hydrocarbon solvent that is liquid at 20 degrees C. and optionally (c) an additional additive component, comprising one or more dispersants, wherein the additives of component (c) are different from the additives of component (a).

### Additive Component (a)

Additive component (a) includes at least one of the following: (i) a quaternary ammonium salt; (ii) a hydrocarbon substituted with at least two carboxy functionalities in the form of acids or one and/or more anhydrides; (iii) a hydrocarbon substituted benzene sulfonic acid.

### (i) The Quaternary Ammonium Salt

The quaternary ammonium salt is the reaction product of: (1) the reaction of a hydrocarbon substituted acylating agent and a compound having an oxygen or nitrogen atom capable of condensing with said acylating agent and further having a tertiary amino group; and (2) a quaternizing agent suitable for converting the tertiary amino group to a quaternary nitrogen.

The quaternizing agent may include dialkyl sulfates, benzyl halides, hydrocarbyl substituted carbonates; hydrocarbyl epoxides in combination with an acid or mixtures thereof.

Examples of quaternary ammonium salt and methods for preparing the same are described in U.S. Pat. Nos. 4,253,980; 3,778,371; 4,171,959; 4,326,973; 4,338,206; and 5,254,138.

The quaternary ammonium salts may be prepared in the presence of a solvent, which may or may not be removed once the reaction is complete. Suitable solvents include, but are not limited to, diluent oil, petroleum naphtha, and certain alcohols. In another embodiment, the solvent of the present invention contains 2 to 20 carbon atoms, 4 to 16 carbon atoms, 6 to 12 carbon atoms, 8 to 10 carbon atoms, or just 8 carbon atoms. In one embodiment, the solvent is an alcohol that contains at least 2 carbon atoms, and in other embodiments at least 4, at least 6 or at least 8 carbon atoms. These alcohols normally have a 2-(C₁₋₄ alkyl) substituent, namely, methyl, ethyl, or any isomer of propyl or butyl. Examples of suitable alcohols include 2-methylheptanol, 2-methyldecanol, 2-hexyldecanol, 2-ethylpentanol, 2-ethylhexanol, 2-ethylnonanol, 2-propylheptanol, 2-butylheptanol, 2-butyloctanol, isooctanol, dodecanol, cyclohexanol, methanol, ethanol, propan-1-ol, 2-methylpropan-2-ol, 2-methylpropan-1-ol, butan-1-ol, butan-2-ol, pentanol and its isomers, and mixtures thereof. In one embodiment the solvent of the present invention is 2-ethylhexanol, 2-ethyl nonanol, 2-methylheptanol, or combinations thereof. In one embodiment the solvent of the present invention includes 2-ethylhexanol.

Hydrocarbyl substituted acylating agents useful in the present invention include the reaction product of a long chain hydrocarbon, generally a polyolefin, with a monounsaturated carboxylic acid or derivative thereof.

Suitable monounsaturated carboxylic acids or derivatives thereof include: (i) □,□-monounsaturated C₄ to C₁₀ dicarboxylic acids, such as fumaric acid, itaconic acid, maleic acid; (ii) derivatives of (i), such as anhydrides or C₁ to C₅ alcohol derived mono- or di-esters of (i); (iii) □,□-monounsaturated C₃ to C₁₀ monocarboxylic acids, such as acrylic acid and methacrylic acid; or (iv) derivatives of (iii), such as C₁ to C₅ alcohol derived esters of (iii).

Suitable long chain hydrocarbons for use in preparing the hydrocarbyl substituted acylating agents include any compound containing an olefinic bond represented by the general Formula I, shown here:

(R¹)(R²)C═C(R³)(CH(R⁴)(R⁵)) (I)

wherein each of R¹, R², R³, R⁴ and R⁵ is, independently, hydrogen or a hydrocarbon based group. In some embodiments at least one of R³, R⁴ or R⁵ is a hydrocarbon based group containing at least 20 carbon atoms.

These long chain hydrocarbons, which may also be described as polyolefins or olefin polymers, are reacted with the monounsaturated carboxylic acids and derivatives described above to form the hydrocarbyl substituted acylating agents used to prepare the nitrogen-containing detergent of the present invention. Suitable olefin polymers include polymers comprising a major molar amount of C₂ to C₂₀, or C₂ to C₅ mono-olefins. Such olefins include ethylene, propylene, butylene, isobutylene, pentene, octene-1, or styrene. The polymers may be homo-polymers, such as polyisobutylene, as well as copolymers of two or more of such olefins. Suitable copolymers include copolymers of ethylene and propylene, butylene and isobutylene, and propylene and isobutylene. Other suitable copolymers include those in which a minor molar amount of the copolymer monomers, e.g. 1 to 10 mole %, is a C₄ to C₁₈ di-olefin. Such copolymers include: a copolymer of isobutylene and butadiene; and a copolymer of ethylene, propylene and 1,4-hexadiene.

In one embodiment, at least one of the —R groups of Formula (I) shown above is derived from polybutene, that is, polymers of C₄ olefins, including 1-butene, 2-butene and isobutylene. C₄ polymers include polyisobutylene. In another embodiment, at least one of the —R groups of Formula I is derived from ethylene-alpha olefin polymers, including ethylene-propylene-diene polymers. Examples of documents that described ethylene-alpha olefin copolymers and ethylene-lower olefin-diene ter-polymers include U.S. Pat. Nos. 3,598,738; 4,026,809; 4,032,700; 4,137,185; 4,156,061; 4,320,019; 4,357,250; 4,658,078; 4,668,834; 4,937,299; and 5,324,800.

In another embodiment, the olefinic bonds of Formula (I) are predominantly vinylidene groups, represented by the following formula:

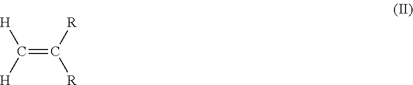

wherein each R is a hydrocarbyl group; which in some embodiments may be:

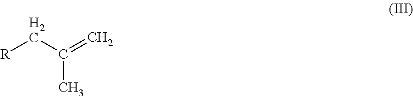

wherein R is a hydrocarbyl group.

In one embodiment, the vinylidene content of Formula (I) may comprise at least 30 mole % vinylidene groups, at least 50 mole % vinylidene groups, or at least 70 mole % vinylidene groups. Such materials and methods of preparation are described in U.S. Pat. Nos. 5,071,919; 5,137,978; 5,137,980; 5,286,823, 5,408,018, 6,562,913, 6,683,138, 7,037,999; and United States publications: 2004/0176552A1; 2005/0137363; and 2006/0079652A1. Such products are commercially available from BASF, under the tradename GLISSOPAL™ and from Texas PetroChemical LP, under the tradename TPC 1105™ and TPC 595™.

Methods of making hydrocarbyl substituted acylating agents from the reaction of monounsaturated carboxylic acid reactants and compounds of Formula (I) are well know in the art and disclosed in: U.S. Pat. Nos. 3,361,673; 3,401,118; 3,087,436; 3,172,892; 3,272,746, 3,215,707; 3,231,587; 3,912,764; 4,110,349; 4,234,435; 6,077,909; and 6,165,235.

In another embodiment, the hydrocarbyl substituted acylating agent can be made from the reaction of a compound represented by Formula (I) with at least one carboxylic reactant represented by the following formulas:

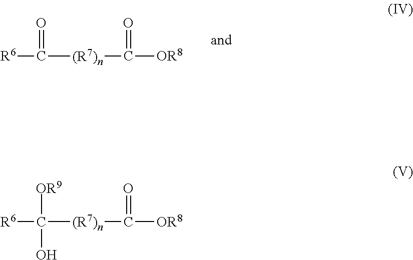

wherein each of R⁶, R⁸ and R⁹ is independently H or a hydrocarbyl group, R⁷ is a divalent hydrocarbylene group, and n is 0 or 1. Such compounds and the processes for making them are disclosed in U.S. Pat. Nos. 5,739,356; 5,777,142; 5,786,490; 5,856,524; 6,020,500; and 6,114,547.

In yet another embodiment, the hydrocarbyl substituted acylating agent may be made from the reaction of any compound represented by Formula (I) with any compound represented by Formula (IV) or Formula (V), where the reaction is carried out in the presence of at least one aldehyde or ketone. Suitable aldehydes include formaldehyde, acetaldehyde, propionaldehyde, butyraldehyde, isobutyraldehyde, pentanal, hexanal. heptaldehyde, octanal, benzaldehyde, as well as higher aldehydes. Other aldehydes, such as dialdehydes, especially glyoxal, are useful, although monoaldehydes are generally preferred. In one embodiment, the aldehyde is formaldehyde, which may be supplied in the aqueous solution often referred to as formalin, but which is more often used in the polymeric form referred to as paraformaldehyde. Paraformaldehyde is considered a reactive equivalent of and/or source of formaldehyde. Other reactive equivalents include hydrates or cyclic trimers. Suitable ketones include acetone, butanone, methyl ethyl ketone, as well as other ketones. In some embodiments, one of the two hydrocarbyl groups of the ketone is a methyl group. Mixtures of two or more aldehydes and/or ketones are also useful. Such hydrocarbyl substituted acylating agents and the processes for making them are disclosed in U.S. Pat. Nos. 5,840,920; 6,147,036; and 6,207,839.

In another embodiment, the hydrocarbyl substituted acylating agent may include methylene bis-phenol alkanoic acid compounds. Such compounds may be the condensation product of (i) an aromatic compound of the formula:

Rₘ—Ar—Z_{c} (VI)

and (ii) at least on carboxylic reactant such as the compounds of formula (IV) and (V) described above, wherein, in Formula (VI): each R is independently a hydrocarbyl group; m is 0 or an integer from 1 up to 6 with the proviso that m does not exceed the number of valences of the corresponding Ar group available for substitution; Ar is an aromatic group or moeity containing from 5 to 30 carbon atoms and from 0 to 3 optional substituents such as amino, hydroxy- or alkyl-polyoxyalkyl, nitro, aminoalkyl, and carboxy groups, or combinations of two or more of said optional substituents; Z is independently —OH, —O, a lower alkoxy group, or —(OR¹⁰)_{b}OR¹¹ wherein each R¹⁰ is independently a divalent hydrocarbyl group, b is a number from 1 to 30, and R¹¹ is —H or a hydrocarbyl group; and c is a number ranging from 1 to 3.

In one embodiment, at least one hydrocarbyl group on the aromatic moiety is derived from polybutene. In one embodiment, the source of the hydrocarbyl groups described above are polybutenes obtained by polymerization of isobutylene in the presence of a Lewis acid catalyst such as aluminum trichloride or boron trifluoride.

Such compounds and the processes for making them are disclosed in U.S. Pat. Nos. 3,954,808; 5,336,278; 5,458,793; 5,620,949; 5,827,805; and 6,001,781.

In another embodiment, the reaction of (i) with (ii), optionally in the presence of an acidic catalyst such as organic sulfonic acids, heteropolyacids, and mineral acids, can be carried out in the presence of at least one aldehyde or ketone. The aldehyde or ketone reactant employed in this embodiment is the same as those described above. Such compounds and the processes for making them are disclosed in U.S. Pat. No. 5,620,949.

Still other methods of making suitable hydrocarbyl substituted acylating agents can be found in U.S. Pat. Nos. 5,912,213; 5,851,966; and 5,885,944.

The succinimide quaternary ammonium salt detergents are derived by reacting the hydrocarbyl substituted acylating agent described above with a compound having an oxygen or nitrogen atom capable of condensing with the acylating agent. In one embodiment, suitable compounds contain at least one tertiary amino group.

In one embodiment, this compound may be represented by one of the following formulas:

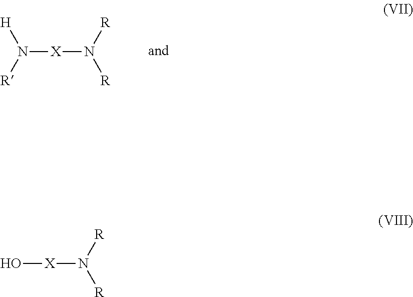

Wherein, for both Formulas (VII) and (VIII), each X is independently a alkylene group containing 1 to 4 carbon atoms; and each R is independently a hydrocarbyl group and R′ is a hydrogen or a hydrocarbyl group, and in some embodiments a hydrogen.

Suitable compounds include but are not limited to: 1-aminopiperidine, 1-(2-aminoethyl)piperidine, 1-(3-aminopropyl)-2-pipecoline, 1-methyl-(4-methylamino)piperidine, 1-amino-2,6-dimethylpiperidine, 4-(1-pyrrolidinyl)piperidine, 1-(2-aminoethyl)pyrrolidine, 2-(2-aminoethyl)-1-methylpyrrolidine, N,N-diethylethylenediamine, N,N-dimethylethylenediamine, N,N-dibutylethylenediamine, N,N,N′-trimethylethylenediamine, N,N-dimethyl-N′-ethylethylenediamine, N,N-diethyl-N′-methylethylenediamine, N,N,N′-triethylethylenediamine, 3-dimethylaminopropylamine, 3-diethylaminopropylamine, 3-dibutylaminopropylamine, N,N,N′-trimethyl-1,3-propanediamine, N,N,2,2-tetramethyl-1,3-propanediamine, 2-amino-5-diethylaminopentane, N,N,N′,N′-tetraethyldiethylenetriamine, 3,3′-diamino-N-methyldipropylamine, 3,3′-iminobis(N,N-dimethylpropylamine), or combinations thereof. In some embodiments the amine used is 3-dimethylaminopropylamine, 3-diethylaminopropylamine, 1-(2-aminoethyl)pyrrolidine, N,N-dimethylethylenediamine, or combinations thereof.

Suitable compounds further include aminoalkyl substituted heterocyclic compounds such as 1-(3-aminopropyl)imidazole and 4-(3-aminopropyl)morpholine, 1-(2-aminoethyl)piperidine, 3,3-diamino-N-methyldipropylamine, 3′3-aminobis(N,N-dimethylpropylamine) These have been mentioned in previous list.

Still further nitrogen or oxygen containing compounds capable of condensing with the acylating agent which also have a tertiary amino group include: alkanolamines, including but not limited to triethanolamine, trimethanolamine, N,N-dimethylaminopropanol, N,N-diethylaminopropanol, N,N-diethylaminobutanol, N,N,N-tris(hydroxyethyl)amine, N,N-dimethylaminoethanol, N,N-diethylaminoethanol, and N,N,N-tris(hydroxymethyl)amine.

Suitable quaternizing agents for preparing any of the quaternary ammonium salt detergents described above include dialkyl sulfates, benzyl halides, hydrocarbyl substituted carbonates, hydrocarbyl epoxides used in combination with an acid, or mixtures thereof.

In one embodiment the quaternizing agent includes: halides such as chloride, iodide or bromide; hydroxides; sulphonates; alkyl sulphates such as dimethyl sulphate; sultones; phosphates; C₁₋₁₂ alkylphosphates; di-C₁₋₁₂ alkylphosphates; borates; C₁₋₁₂ alkylborates; nitrites; nitrates; carbonates; bicarbonates; alkanoates; O,O-di-C₁₋₁₂ alkyldithiophosphates; or mixtures thereof.

In one embodiment the quaternizing agent may be: a dialkyl sulphate such as dimethyl sulphate; N-oxides; sultones such as propane or butane sultone; alkyl, acyl or aralkyl halides such as methyl and ethyl chloride, bromide or iodide or benzyl chloride; hydrocarbyl (or alkyl) substituted carbonates; or combinations thereof. If the aralkyl halide is benzyl chloride, the aromatic ring is optionally further substituted with alkyl or alkenyl groups.

The hydrocarbyl (or alkyl) groups of the hydrocarbyl substituted carbonates may contain 1 to 50, 1 to 20, 1 to 10 or 1 to 5 carbon atoms per group. In one embodiment the hydrocarbyl substituted carbonates contain two hydrocarbyl groups that may be the same or different. Examples of suitable hydrocarbyl substituted carbonates include dimethyl or diethyl carbonate.

In another embodiment the quaternizing agent can be a hydrocarbyl epoxides, as represented by the following formula:

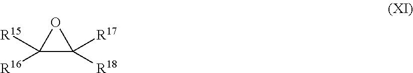

wherein R¹⁵, R¹⁶, R¹⁷ and R¹⁸ can be independently H or a C₁₋₅₀ hydrocarbyl group. Examples of suitable hydrocarbyl epoxides include: styrene oxide, ethylene oxide, propylene oxide, butylene oxide, stilbene oxide, C₂₋₅₀ epoxides, or combinations thereof.

Any of the quaternizing agents described above, including the hydrocarbyl epoxides, may be used in combination with an acid. Suitable acids include carboxylic acids, such as acetic acid, propionic acid, butyric acid, and the like.

In some embodiments the quaternary ammonium salt contains at least 30, 40 or even 50 carbon atoms, and in some embodiments the additive contains at least one hydrocarbyl group containing at least 30, 40 or even 40 carbon atoms, and in still other embodiments the additive contains only one such hydrocarbyl group.

In some embodiments the hydrocarbon group of the quaternary ammonium salt is derived from polyisobutylene and has a number average molecular weight (Mn) of at least 800, 900 or even 1000. In some embodiments the hydrocarbon has a Mn of from 800 or 900 or 1,000 up to 5,000 or 3,000 or 2,000 or even 1,500.

The succinimide quaternary ammonium salt detergents of the present invention are formed by combining the reaction product described above (the reaction product of a hydrocarbyl-substituted acylating agent and a compound having an oxygen or nitrogen atom capable of condensing with said acylating agent and further having at least one tertiary amino group) with a quaternizing agent suitable for converting the tertiary amino group to a quaternary nitrogen. Suitable quaternizing agents are discussed in greater detail below. In some embodiments these preparations may be carried out neat or in the presence of a solvent, as described above. By way of non-limiting example, preparations of succinimide quaternary ammonium salts are provided below.

### Example Q-1

Polyisobutylene succinic anhydride (100 pbw), which itself is prepared by reacting 1000 number average molecular weight high vinylidene polyisobutylene and maleic anhydride, is heated to 80° C. and is charged to a jacketed reaction vessel fitted with stirrer, condenser, feed pump attached to subline addition pipe, nitrogen line and thermocouple/temperature controller system. The reaction vessel is heated to 100° C. Dimethylaminopropylamine (10.9 pbw) is charged to the reaction, maintaining the batch temperature below 120° C., over an 8 hour period. The reaction mixture is then heated to 150° C. and maintained at temperature for 4 hours, resulting in a non-quaternized succinimide detergent.

A portion of the non-quaternized succinimide detergent (100 pbw) is then charged to a similar reaction vessel. Acetic acid (5.8 pbw) and 2-ethylhexanol (38.4 pbw) are added to the vessel and the mixture is stirred and heated to 75° C. Propylene oxide (8.5 pbw) is added to the reaction vessel over 4 hours, holding the reaction temperature at 75° C. The batch is held at temperature for 4 hours. The resulting product contains a quaternized succinimide detergent.

### Example Q-2

A quaternized succinimide detergent is prepared by first preparing a non-quaternized succinimide detergent from a mixture of polyisobutylene succinic anhydride, as described above, (100 pbw) and diluent oil—pilot 900 (17.6 pbw) which are heated with stirring to 110° C. under a nitrogen atmosphere. Dimethylaminopropylamine (DMAPA, 10.8 pbw) is added slowly over 45 minutes maintaining batch temperature below 115° C. The reaction temperature is increased to 150° C. and held for a further 3 hours. The resulting compound is a DMAPA succinimide non-quaternized detergent. A portion of this non-quaternized succinimide detergent (100 pbw) is heated with stirring to 90° C. Dimethylsulphate (6.8 pbw) is charged to the reaction vessel and stirring is resumed at 300 rpm under a nitrogen blanket. The resulting exotherm raises the batch temperature to ˜0.100° C. The reaction is maintained at 100° C. for 3 hours before cooling back and decanting. The resulting product contains a methylsulphate quaternary ammonium salt derived from dimethylsulphate.

(ii) The Hydrocarbon Substituted with at Least Two Carboxy Functionalities.

Another suitable additive is a hydrocarbon substituted with at least two carboxy functionalities in the form of acids and/or one or more anhydrides. In some embodiments the additive is a hydrocarbon substituted with at least two carboxy functionalities in the form of acids and/or anhydrides. In other embodiments the additive is a hydrocarbyl-substituted succinic acylating agent. In other embodiments the substituted hydrocarbon additive is a dimer acid compound. In still other embodiments the substituted hydrocarbon additive of the present invention includes a combination of two or more of the additives described in this section.

The substituted hydrocarbon additives of the present invention, when used in the compositions and method described herein, reduce the tendency of fuel compositions in which they are used to pick up metals.

The substituted hydrocarbon additives may include dimer acids. Dimer acids are a type of di-acid polymer derived from fatty acids, which contain acid functionality. In some embodiments, the dimer acid used in the present invention is derived from C10 to C20 fatty acids, C12 to C18 fatty acids, and/or C16 to C18 fatty acids.

The substituted hydrocarbon additives may include succinic acids, halides, anhydrides and combination thereof. In some embodiments the agents are acids or anhydrides, and in other embodiments the agents are anhydrides, and in still other embodiments the agents are hydrolyzed anhydrides. The hydrocarbon of the substituted hydrocarbon additive and/or the primary hydrocarbyl group of the hydrocarbyl-substituted succinic acylating agent generally contains an average of at least about 8, or about 30, or about 35 up to about 350, or to about 200, or to about 100 carbon atoms. In one embodiment, the hydrocarbyl group is derived from a polyalkene.

The polyalkene may be characterized by a Mn (number average molecular weight) of at least about 300. Generally, the polyalkene is characterized by an Mn of about 500, or about 700, or about 800, or even about 900 up to about 5000, or to about 2500, or to about 2000, or even to about 1500. In another embodiment n varies between about 300, or about 500, or about 700 up to about 1200 or to about 1300.

The polyalkenes include homopolymers and interpolymers of polymerizable olefin monomers of 2 to about 16 or to about 6, or to about 4 carbon atoms. The olefins may be monoolefins such as ethylene, propylene, 1-butene, isobutene, and 1-octene; or a polyolefinic monomer, such as diolefinic monomer, such 1,3-butadiene and isoprene. In one embodiment, the interpolymer is a homopolymer. An example of a polymer is a polybutene. In one instance about 50% of the polybutene is derived from isobutylene. The polyalkenes are prepared by conventional procedures.

In one embodiment, the hydrocarbyl groups are derived from polyalkenes having an Mn of at least about 1300, or about 1500, or about 1600 up to about 5000, or to about 3000, or to about 2500, or to about 2000, or to about 1800, and the Mw/Mn is from about 1.5 or about 1.8, or about 2, or to about 2.5 to about 3,6, or to about 3.2. In some embodiments the polyalkene is polyisobutylene with a molecular weight of 800 to 1200. The preparation and use of substituted hydrocarbons and/or substituted succinic acylating agents, wherein the hydrocarbon and/or substituent is derived from such polyalkenes are described in U.S. Pat. No. 4,234,435, the disclosure of which is hereby incorporated by reference.

In another embodiment, the substituted hydrocarbon and/or succinic acylating agents are prepared by reacting the above described polyalkene with an excess of maleic anhydride to provide substituted succinic acylating agents wherein the number of succinic groups for each equivalent weight of substituent group is at least 1.3, or to about 1.5, or to about 1.7, or to about 1.8. The maximum number generally will not exceed 4.5, or to about 2.5, or to about 2.1, or to about 2.0. The polyalkene here may be any of those described above.

In another embodiment, the hydrocarbon and/or hydrocarbyl group contains an average from about 8, or about 10, or about 12 up to about 40, or to about 30, or to about 24, or to about 20 carbon atoms. In one embodiment, the hydrocarbyl group contains an average from about 16 to about 18 carbon atoms. In another embodiment, the hydrocarbyl group is tetrapropenyl group. In one embodiment, the hydrocarbyl group is an alkenyl group.

The hydrocarbon and/or hydrocarbyl group may be derived from one or more olefins having from about 2 to about 40 carbon atoms or oligomers thereof. These olefins are preferably alpha-olefins (sometimes referred to as mono-1-olefins) or isomerized alpha-olefins. Examples of the alpha-olefins include ethylene, propylene, butylene, 1-octene, 1-nonene, 1-decene, 1-dodecene, 1-tridecene, 1-tetradecene, 1-pentadecene, 1-hexadecene, 1-heptadecene, 1-octadecene, 1-nonadecene, 1-eicosene, 1-henicosene, 1-docosene, 1-tetracosene, etc. Commercially available alpha-olefin fractions that may be used include the C₁₅₋₁₈ alpha-olefins, C₁₂₋₁₆ alpha-olefins, C₁₄₋₁₆ alpha-olefins, C₁₄₋₁₈ alpha-olefins, C₁₆₋₁₈ alpha-olefins, C₁₆₋₂₀ alpha-olefins, C₂₂₋₂₈ alpha-olefins, etc. In one embodiment, the olefins are C16 and C₁₆₋₁₈ alpha-olefins. Additionally, C₃₀+ alpha-olefin fractions can be used. In one embodiment, the olefin monomers include ethylene, propylene and 1-butene.

Isomerized alpha-olefins are alpha-olefins that have been converted to internal olefins. The isomerized alpha-olefins suitable for use herein are usually in the form of mixtures of internal olefins with some alpha-olefins present. The procedures for isomerizing alpha-olefins are well known to those in the art. Briefly these procedures involve contacting alpha-olefin with a cation exchange resin at a temperature in a range of about 80° to about 130° C. until the desired degree of isomerization is achieved. These procedures are described for example in U.S. Pat. No. 4,108,889 which is incorporated herein by reference.

The mono-olefins may be derived from the cracking of paraffin wax. The wax cracking process yields both even and odd number C₆₋₂₀ liquid olefins of which 85% to 90% are straight chain 1-olefins. The balance of the cracked wax olefins is made up of internal olefins, branched olefins, diolefins, aromatics and impurities. Distillation of the C₆₋₂₀ liquid olefins, obtained from the wax cracking process, yields fractions (e.g., C₁₅₋₁₈ alpha-olefins) which are useful in preparing the succinic acylating agents.

Other mono-olefins can be derived from the ethylene chain growth process. This process yields even numbered straight-chain 1-olefins from a controlled Ziegler polymerization. Other methods for preparing the mono-olefins include chlorination-dehydrochlorination of paraffin and catalytic dehydrogenation of paraffins.

The above procedures for the preparation of mono-olefins are well known to those of ordinary skill in the art and are described in detail under the heading “Olefins” in the Encyclopedia of Chemical Technology, Second Edition, Kirk and Othmer, Supplement, Pages 632,657, Interscience Publishers, Div. of John Wiley and Son, 1971, which is hereby incorporated by reference for its relevant disclosures pertaining to methods for preparing mono-olefins.

Succinic acylating agents are prepared by reacting the above-described olefins, isomerized olefins or oligomers thereof with unsaturated carboxylic acylating agents (unsaturated carboxylic reactants), such as itaconic, citraconic, or maleic acylating agents at a temperature of about 160°, or about 185° C. up to about 240° C., or to about 210° C. Maleic acylating agents are the preferred unsaturated acylating agent. The procedures for preparing the acylating agents are well known to those skilled in the art and have been described for example in U.S. Pat. No. 3,412,111; and Ben et al, “The Ene Reaction of Maleic Anhydride With Alkenes”, J. C. S. Perkin II (1977), pages 535-537. These references are incorporated by reference for their disclosure of procedures for making the above acylating agents. In one embodiment, the alkenyl group is derived from oligomers of lower olefins, i.e., olefins containing from 2 to about 6, or about 4 carbon atoms. Examples of these olefins include ethylene, propylene and butylene.

The olefin, olefin oligomer, or polyalkene may be reacted with the carboxylic reagent such that there is at least one mole of carboxylic reagent for each mole of olefin, olefin oligomer, or polyalkene that reacts. Preferably, an excess of carboxylic reagent is used. In one embodiment, this excess is between about 5% to about 25%. In another embodiment, the excess is greater than 40%, or greater than 50%, and even greater than 70%.

The conditions, i.e., temperature, agitation, solvents, and the like, for forming the hydrocarbyl-substituted succinic acylating agent, are known to those in the art. Examples of patents describing various procedures for preparing useful acylating agents include U.S. Pat. Nos. 3,172,892 (Le Suer et al.); 3,215,707 (Rense); 3,219,666 (Norman et al); 3,231,587 (Rense); 3,912,764 (Palmer); 4,110,349 (Cohen); and 4,234,435 (Meinhardt et al); and U.K. 1,440,219. The disclosures of these patents are hereby incorporated by reference.

In some embodiments the substituted hydrocarbon additives and/or hydrocarbyl substituted succinic acylating agents suitable for use in the present invention contain di-acid functionality. In other embodiments, which may be used alone or in combination with the embodiments described above, the hydrocarbyl group of the hydrocarbyl substituted succinic acylating agent is derived from polyisobutylene and the di-acid functionality of the agent is derived from carboxylic acid groups, such as hydrocarbyl substituted succinic acid.

In some embodiments the hydrocarbyl substituted acylating agent comprises one or more hydrocarbyl substituted succinic anhydride groups. In some embodiments the hydrocarbyl substituted acylating agent comprises one or more hydrolyzed hydrocarbyl substituted succinic anhydride groups.

In some embodiments the hydrocarbyl substituents of the acylating agents described above are derived from homopolymers and/or copolymers containing 2 to 10 carbon atoms. In some embodiments the hydrocarbyl substituents of any of the acylating agents described above are derived from polyisobutylene.

In some embodiments the hydrocarbon substituted with at least two carboxy functionalities in the form of acids and/or one or more anhydrides contains at least 30, 40 or even 50 carbon atoms, and in some embodiments the additive contains at least one hydrocarbyl group containing at least 30, 40 or even 40 carbon atoms, and in still other embodiments the additive contains only one such hydrocarbyl group.

In some embodiments the hydrocarbon substituted with at least two carboxy functionalities in the form of acids and/or one or more anhydrides has a number average molecular weight (Mn) of at least 800, 900 or even 1000. In some embodiments the hydrocarbon has a Mn of from 800 or 900 or 1,000 up to 5,000 or 3,000 or 2,000 or even 1,500.

In some embodiments the additive component contains: (i) a quaternary ammonium salt; and/or (ii) a hydrocarbon substituted with at least two carboxy functionalities in the form of acids and/or one or more anhydrides.

(iii) The Hydrocarbon Substituted Benzene Sulfonic Acid.

Another suitable additive is a hydrocarbon substituted benzene sulfonic acid

In some embodiments the hydrocarbon substituted benzene sulfonic acid contains from 10 or 12 to 16 or 14 carbon atoms, and in some embodiments the additive contains at least one hydrocarbyl group containing from 10 or 12 to 16 or 14 carbon atoms, and in still other embodiments the additive contains only one such hydrocarbyl group. In some embodiments the hydrocarbon substituted benzene sulfonic acid contains from 18 to 24 carbon atoms.

In some embodiments the additive component of the invention is substantially free to free of mixed acid-ester succinic acids, overbased phenate detergents, sulfonate detergents, polyisobutylene (PIB)-based succinimides, PIB-based esters, or any combination thereof.

### Hydrocarbon Solvent Component (b)

Component (b) is a hydrocarbon solvent that is liquid at 20 degrees C. In some embodiments the solvent includes an aromatic solvent, such as heavy aromatic naptha solvent, a branched fatty alcohol containing at least 8 carbon atoms, or a combination thereof. Suitable solvents include solvents of high aromatic content, such as having an aromatic content of greater than 35%, 45%, 50% or even 60% by weight.

Examples of suitable solvents also include alcohols such as methanol, ethanol, isopropanol, isobutanol, secondary butanol, glycols (e.g., ethylene glycol, ethylene glycol monobutyl ether, and the like), aliphatic and aromatic hydrocarbons, the like, and combinations thereof. In some embodiments, the described compounds are sparingly or fully water-soluble and as such compositions may be suitably formulated in a mixture of water and one or more alcohols or glycols. Similarly, the described compounds may be suitably formulated in an aromatic naptha, such as heavy aromatic naptha, by incorporating one or more alcohols or glycols in the composition.

In some embodiments the solvent component is free to substantially free of No. 2 ultra low sulfur diesel (ULSD). In other embodiments the solvent component is free to substantially free of diesel fuel. In some embodiments the solvent component is free of aliphatic solvents. In some embodiments the solvent component is free of solvents that have an aromatic content of less than 50%, 40%, 37% or even 35% by weight. In some embodiments the solvent component is free of diesel fuel that have an aromatic content of less than 50%, 40%, 37% or even 35% by weight.

### Additional Additive Component (c)

The described compounds and compositions may be used alone or in combination with other compounds. Typical combinations include pour point depressants and/or surfactants.

Examples of suitable pour point depressants are C1-C3 linear or branched alcohols, ethylene, and propylene glycol. Examples of suitable surfactants are ethoxylated nonylphenols and/or ethoxylated amines as wetting agents or additives for dispersing the compound into the fluid stream to which they are added. The surfactant may be water-soluble to allow the product to better wet the surface of the flow line where corrosion may take place. Water-soluble surfactants utilized may be non-ionic, cationic, or anionic and will generally have a hydrophilic lipophilic balance (HLB) value greater than 7.

Oil-soluble surfactants may be utilized if it is desired to disperse the composition into a hydrocarbon fluid. Oil-soluble surfactants may be non-ionic, cationic, or anionic. These surfactants typically have an HLB value less than 7. In some embodiments the compositions of the present invention are substantially free to free of water-soluble surfactants and in such embodiments the compositions is not used in water-based applications.

In alternative embodiments, formulations may include components such as phosphate esters and mercapto synergists. The composition may also include one or more suitable solvents including, but not limited to water, monoethylene glycol, ethylene glycol, ethylene glycol monobutyl ether, methanol, isopropanol, the like, derivatives thereof, and combinations thereof.

Other compounds that may also be blended with the compositions claimed herein are quaternary amines, such as fatty, cyclic, or aromatic amines quaternized with lower alkyl halides or benzyl chloride and certain amides. In addition, filming agents, such as p-toluenesulfonic acid and dodecylbenzenesulfonic acid, may also be used. The described compositions may also contain components that are typically included in corrosion inhibiting compositions, such as scale inhibitors and/or surfactants. In some instances, it may be desirable to include a biocide in the composition.

In some embodiments the optional additional additive component of the described compositions includes (i) a dispersant derived from the reaction of a polyisobutylene succinic anhydride and a polyamine; (ii) a dispersant derived from the reaction of a polyisobutylene succinic anhydride and a polyol; (iii) a dispersant derived from the reaction of a polyisobutylene succinic anhydride, a polyol and a polyamine, or combinations thereof. In some embodiments the polyol may include pentaerythritol and/or the polyamine may include polyethylenepolyamines, tetraethylenepentamine, or combinations thereof.

As noted above the specific formulations of the compositions of the present invention are not overly limited and the most effective compositions for a specific application is expected to vary somewhat between specific applications. However, generally, the compositions of the present invention may be formulated such that component (a) is present in the composition from 1 to 50 percent by weight, component (b) is present in the composition from 50 to 99 percent by weight and wherein component (c) is present in the composition from 0 to 49 percent by weight.

In still other embodiments component (a) may be present in the composition from 1, 2 or 5 percent by weight up to 50, 20 or 10 percent by weight; component (b) may be present in the composition from 50, 80 or 90 percent by weight up to 99, 98 or 95 percent by weight; component (c) may be present in the composition from 0, 2, 5 or 10 percent by weight up 49, 30, 20 or 10 percent by weight; where these weight percents are with regards to the additive composition.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include: hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring); substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy); hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. In addition the acylating agents and/or substituted hydrocarbon additives of the present invention may form salts or other complexes and/or derivatives, when interacting with other components of the compositions in which they are used. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above. The term “substantially free of” as used herein may mean any one of the following: containing an amount insufficient to significantly alter the character and/or performance of the composition; less than 5, 4, 2, 1, 0.5, 0.1 or even 0.01 percent by weight; less than 1,000, 500, 100 or even 10 ppm; a small amount due to contamination and/or typical of such commercial materials; a trace amount; or no measurable amount.

### EXAMPLES

The invention will be further illustrated by the following examples, which sets forth particularly advantageous embodiments. While the examples are provided to illustrate the present invention, they are not intended to limit it.

### Example Set 1

A set of examples is prepared and tested to evaluate various compositions' abilities to break up and dissolve pipeline deposits. The pipeline deposits used in this testing are samples of deposits from the wall of a commercial gas pipeline. A deposit samples are from the same source of deposits.

The same test procedure is used for each example. A test composition is prepared by mixing the additive to be tested into a solvent at a 10:90 weight ratio (where the additive being tested may itself contain some amount of diluent oil). The test composition is placed in a sample bottle containing 50 mL of the test composition prepared above and a 0.5 gram piece of solid pipeline deposit is added to the bottle. Each bottle is then observed to determine the extent to which, if any, the solid deposit breaks up and/or dissolves into the test composition.

The additives tested and the results obtained for each test composition are summarized in the table below.

TABLE 1
Pipeline Deposit Test

| EXAMPLE | ADDITIVE (A) | SOLVENT (B) | |
|---|---|---|---|
| ID | ~10% | ~90% | RESULTS |
| 1-A | PIB-based succinic acid | HAN | Solid deposit partially |
| | | | broken up and dissolved. |
| 1-B | Dodecylbenzenesulfonic acid | HAN | Solid deposit partially |
| | | | broken up and dissolved. |
| 1-C | PIB-based quaternary salt | HAN | Solid deposit broken up |
| | | | and fully dissolved. |
| 1-D | Mixed acid-ester PIB-based | HAN | No effect observed. |
| | succinic acid | | |
| 1-E | Overbased Ca phenate detergent | HAN | No effect observed. |
| 1-F | Ca sulfonate detergent | HAN | No effect observed. |
| 1-G | PIB-based succinimide | HAN | No effect observed. |
| 1-H | PIB-based ester | HAN | No effect observed. |
| 1-I | PIB-based ester | HAN | No effect observed. |
| 1-J | PIB-based succinic acid | No. 2 DIESEL | No effect observed. |
| 1-K | PIB-based quaternary salt | No. 2 DIESEL | No effect observed. |
| 1-L | Mixed acid-ester PIB-based | No. 2 DIESEL | No effect observed. |
| | succinic acid | | |
| 1-M | Overbased Ca phenate detergent | No. 2 DIESEL | No effect observed. |
| 1-N | Ca sulfonate detergent | No. 2 DIESEL | No effect observed. |
| 1-O | PIB-based succinimide | No. 2 DIESEL | No effect observed. |
| 1-P | PIB-based ester | No. 2 DIESEL | No effect observed. |
| 1-Q | PIB-based ester | No. 2 DIESEL | No effect observed. |

1 - HAN is heavy aromatic naphtha.
2 - The No. 2 Diesel is No. 2 USLD fuel, which is required to have an aromatic content of 35% or less.

The results show that the compositions of the invention, specifically Examples 1-A to 1-C, break up and at least partially dissolve oil pipeline solid deposits, while various other materials do not. Also, the results so the solvent of the invention plays an important role as well, as the combination of the described additives and solvents are required to achieve the good results.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicates all percent values and ppm values herein are weight percent values and/or calculated on a weight basis and are relative to the overall additive composition. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

We claim:

1. A method of removing deposits in oil and/or gas handling equipment comprising the steps of (I) supplying to internal surfaces of said equipment a composition comprising:
(a) an additive component comprising at least one of the following:
(i) a quaternary ammonium salt comprising the reaction product of: (1) the reaction of a hydrocarbon substituted acylating agent and a compound having an oxygen or nitrogen atom capable of condensing with said acylating agent and further having a tertiary amino group; and (2) a quaternizing agent suitable for converting the tertiary amino group to a quaternary nitrogen;
(ii) a hydrocarbon substituted with at least two carboxy functionalities in the form of acids and/or one or more anhydrides;
(iii) a hydrocarbon substituted benzene sulfonic acid; and
(b) a hydrocarbon solvent that is liquid at 20 degrees C.

2. The method of claim 1 wherein the hydrocarbon group of deposit additive (i) and/or (ii) contains at least 30 carbon atoms; and
wherein the quaternizing agent of deposit additive (i) is selected from the group consisting of dialkyl sulfates, benzyl halides, hydrocarbyl substituted carbonates; hydrocarbyl epoxides optionally in combination with an acid; or mixtures thereof.

3. The method of claim 1 wherein the hydrocarbon group of deposit additive (i) and/or (ii) is derived from polyisobutylene that has a number average molecular weight of at least 800.

4. The method of claim 1 wherein the hydrocarbon group of deposit additive (iii) contains from 10 to 14 carbon atoms.

5. The method of claim 1 wherein component (b) comprises a heavy aromatic naptha solvent, a branched fatty alcohol containing at least 8 carbon atoms, or a combination thereof.

6. The method of claim 1 wherein the composition further comprises component (c), an additive component, comprising one or more dispersants, wherein the additives of component (c) are different from the additives of component (a).

7. The method of claim 6 wherein component (c) comprises: a dispersant derived from the reaction of a polyisobutylene succinic anhydride and a polyamine; a dispersant derived from the reaction of a polyisobutylene succinic anhydride and a polyol; a dispersant derived from the reaction of a polyisobutylene succinic anhydride, a polyol and a polyamine, or combinations thereof.

8. The method of claim 1 wherein the oil and/or gas handling equipment comprises flowlines, pipelines, injection lines, wellbore surfaces, storage tanks, process equipment, vessels, water injection systems, and combinations thereof.

9. The method of claim 6 wherein component (a) is present in the composition from 1 to 50 percent by weight, wherein component (b) is present in the composition from 50 to 99 percent by weight and wherein component (c) is present in the composition from 0 to 49 percent by weight.

10. The method of claim 1 wherein the oil and/or gas handling equipment comprises an oil and/or gas pipeline and wherein the method removes deposits from the internal wall of said pipeline, where said composition is supplied to the wall of said pipeline.

11. The method of claim 10 wherein the method includes the use of a pipeline pig.

12. The method of claim 1 wherein the method results in the removal of carbonaceous deposits from the internal surfaces of said oil and/or gas handling equipment.

13. An oil and/or gas handling equipment deposit control composition comprising:
(a) an additive component comprising at least one of the following:
(i) a quaternary ammonium salt comprising the reaction product of: (1) the reaction of a hydrocarbon substituted acylating agent and a compound having an oxygen or nitrogen atom capable of condensing with said acylating agent and further having a tertiary amino group; and (2) a quaternizing agent suitable for converting the tertiary amino group to a quaternary nitrogen;
(ii) a hydrocarbon substituted with at least two carboxy functionalities in the form of acids or at least one carboxy functionality in the form an anhydride;
(iii) a hydrocarbon substituted benzene sulfonic acid; and
(b) a hydrocarbon solvent that is liquid at 20 degrees C.; and
(c) an optional additive component, comprising one or more dispersants, wherein the additives of component (c), when present, are different from the additives of component (a).

14. The composition of claim 13 wherein component (a) is present in the composition from 1 to 50 percent by weight, wherein component (b) is present in the composition from 50 to 99 percent by weight and wherein component (c) is present in the composition from 0 to 49 percent by weight.

15. The use of composition to control deposits in oil and/or gas handling equipment wherein said composition comprises:
(a) an additive component comprising at least one of the following:
(i) a quaternary ammonium salt comprising the reaction product of (1) the reaction of a hydrocarbon substituted acylating agent and a compound having an oxygen or nitrogen atom capable of condensing with said acylating agent and further having a tertiary amino group; and (2) a quaternizing agent suitable for converting the tertiary amino group to a quaternary nitrogen;
(ii) a hydrocarbon substituted with at least two carboxy functionalities in the form of acids or at least one carboxy functionality in the form an anhydride;
(iii) a hydrocarbon substituted benzene sulfonic acid; and
(b) a solvent component with a flash point of at least 60 degrees C.; and
(c) an optional additive component, comprising one or more dispersants, wherein the additives of component (c), when present, are different from the additives of component (a).
